(19) United States
(12) Patent Application Publication
(10) Pub. No.: US 2015/0242297 A1
(43) Pub. Date: Aug. 27, 2015

(54) METHOD AND SYSTEM FOR TESTING OF APPLICATIONS IN ASSET MANAGEMENT SOFTWARE

(71) Applicant: TOTAL RESOURCE MANAGEMENT, INC., Alexandria, VA (US)

(72) Inventors: Albert M. JOHNSON, JR., Falls Church, VA (US); Andrew Joseph MAHEN, Arlington, VA (US); Jordan Pressler ORTIZ, Alexandria, VA (US)

(73) Assignee: TOTAL RESOURCE MANAGEMENT, INC., Alexandria, VA (US)

(21) Appl. No.: 14/628,684

(22) Filed: Feb. 23, 2015

Related U.S. Application Data
(63) Continuation-in-part of application No. 14/197,022, filed on Mar. 4, 2014.
(60) Provisional application No. 61/943,050, filed on Feb. 21, 2014.
(60) Provisional application No. 62/072,046, filed on Oct. 29, 2014.

(51) Int. Cl. G06F 11/30; G06F 11/34

(52) U.S. Cl. CPC G06F 11/302; G06F 11/3051; G06F 11/3466

(57) ABSTRACT

A method for testing asset management software applications includes: interfacing a user computing device with a computing server, the server being configured to execute an asset management application program; displaying, on the user computing device, a user interface configured to enable a user to perform functions associated with the asset management application program; recording a plurality of user input actions using the interface; generating a program script configured to, upon execution by the computing server, automate performance of each of the recorded plurality of user input actions; executing at least one instance of the generated program script; and measuring one or more performance metrics associated with performance of the computing server during execution of the at least one instance of the generated program script.

### RELATED APPLICATIONS

This application is related to commonly assigned U.S. Provisional Patent Application No. 61/772,353, filed on Mar. 4, 2013, entitled “Method and System of Facilitating Access to Asset Management Software” to Albert M. Johnson et al.; U.S. Provisional Patent Application No. 61/943,050, filed on Feb. 21, 2014, entitled “Method and System of Facilitating Access to Asset Management Software” to Albert M. Johnson Jr. et al.; U.S. patent application Ser. No. 14/197,002, filed on Mar. 4, 2014, entitled “Method and System of Displaying Context-Based Completion Values in an Integrated Development Environment for Asset Management Software” to Albert M. Johnson Jr. et al.; and U.S. Patent Application No. 62/072,046, filed on Oct. 29, 2014, entitled “Method and System of Displaying Context-Based Completion Values in an Integrated Development Environment for Asset Management Software” to Albert M. Johnson Jr. et al., all of which are herein incorporated by reference in their entirety.

### FIELD

The present disclosure relates to the testing of applications in asset management software, specifically the use of scripting to automate the execution of recorded user input actions over a plurality of instances to test performance of a computing server configured to execute an asset management application program.

### BACKGROUND

Enterprise asset management software is used by entities to operate, maintain, and manage enterprise assets. Many such software products, such as Maximo by IBM®, provide for the management of assets across multiple departments, locations, facilities, and business units for businesses and other entities. However, as asset management software is often designed to be useful for a broad range of entities and industries, such software may lack specific features that may be beneficial or necessary for certain entities. As a result, application programming interfaces may be available to interact with the software or its associated data, which may be used by an entity to develop additional functionality of the software.

However, due to the complicated nature of asset management software and the storage and maintenance of related assets, developing such functionality may be exceedingly difficult. In particular, the writing of scripts and programming code to interact with the asset management software may present a high level of difficulty to users. Thus, there is a perceived need for a solution to access context-based values and relationships in the database on the asset management software server for presentation to a user of a local system for inclusion in an integrated development environment.

Additional information can be found in U.S. Patent Publication No. 2012/0316906, entitled “Spatial-Temporal Optimization of Physical Asset Maintenance”; U.S. Patent Publication No. 2012/0297445, entitled “Method of Managing Asset Associated with Work Order or Element Associated with Asset, and System and Computer Program for the Same”; U.S. Patent Publication No. 2012/0296685, entitled “Method of Managing Access Right, and System for Computer Program for the Same”; U.S. Patent Publication No. 2012/0095926, entitled “Method of Managing Asset Associated with Work Order or Element Associated with Asset, and System and Computer Program for the Same”; U.S. Patent Publication No. 2012/0095797, entitled “Method of Managing Access Right, and System and Computer Program for the Same”; U.S. Patent Publication No. 2012/0084560, entitled “Reboot Controller to Prevent Unauthorized Reboot”; U.S. Patent Publication No. 2012/0059684, entitled “Spatial-Temporal Optimization of Physical Asset Maintenance”; U.S. Patent Publication No. 2011/0213508, entitled “Optimizing Power Consumption by Dynamic Workload Adjustment”; U.S. Patent Publication No. 2011/0029767, entitled “System and Method for Transforming Configuration Data Items in a Configuration Management Database”; U.S. Patent Publication No. 2010/0010791, entitled “System and Method for Constructing Flexible Ordering to Improve Productivity and Efficiency in Process Flows”; U.S. Patent Publication No. 2009/0326884, entitled “Techniques to Predict Three-Dimensional Thermal Distributions in Real-Time”; and U.S. Patent Publication No. 2009/0288078, entitled “Method and Apparatus for Deploying Applications,” all of which are herein incorporated by reference in their entirety.

### SUMMARY

The present disclosure provides a description of systems and methods for testing asset management software applications.

A method for testing asset management software applications includes: interfacing, in a computing network, a user computing device with a computing server, wherein the computing server is configured to execute an asset management application program; displaying, by a display of the user computing device, a user interface configured to enable a user of the user computing device to perform functions associated with the asset management application program; recording, by a recording device, a plurality of user input actions using the displayed user interface, wherein each user input action includes performance of a function associated with the asset management application program; generating a program script configured to, upon execution by the computing server, automate performance of each of the recorded plurality of user input actions; executing, by a processing device of the computing server, at least one instance of the generated program script; and measuring, by the processing device of the computing server, one or more performance metrics associated with performance of the computing server during execution of the at least one instance of the generated program script.

A system for testing asset management software applications includes a computing network configured to interface a user computing device with a computing server, wherein the computing server is configured to execute an asset management application program. A display of the user computing device is configured to display a user interface configured to enable a user of the user computing device to perform functions associated with the asset management application program. The system also includes a recording device configured to record a plurality of user input actions using the displayed user interface, wherein each user input action includes performance of a function associated with the asset management application program. The system further includes a first processing device configured to generate a program script configured to, upon execution by the computing server, automate performance of each of the recorded plurality of user input actions. The computing server includes a processing device configured to: execute at least one instance of the generated program script; and measure one or more performance metrics associated with performance of the computing server during execution of the at least one instance of the generated program script.

### BRIEF DESCRIPTION OF THE DRAWING FIGURES

The scope of the present disclosure is best understood from the following detailed description of exemplary embodiments when read in conjunction with the accompanying drawings. Included in the drawings are the following figures:

FIG. 1 is a high level architecture illustrating a system for displaying context-based completion values based on asset management software data in an integrated development environment in accordance with exemplary embodiments.

FIG. 2 is a block diagram illustrating the computing device of FIG. 1 for the retrieval of context-based completion values from an asset database of an asset management server and display thereof in accordance with exemplary embodiments.

FIG. 3 is a flow diagram illustrating a process of the computing device of FIG. 2 for identifying context-based completion values for display in accordance with exemplary embodiments.

FIGS. 4A-4D are diagrams illustrating a graphical user interface for the display of context-based completion values from an asset database of an asset management server based on completion attributes in accordance with exemplary embodiments.

FIG. 5 is flow chart illustrating an exemplary method for the display of context-based completion values in an integrated development environment in accordance with exemplary embodiments.

FIG. 6 is a flow diagram illustrating a process of the computing device of FIG. 2 for displaying and operating a guide to user action for use of asset management software in accordance with exemplary embodiments.

FIGS. 7A and 7B are diagrams illustrating a graphical user interface for the display of a guide to user action for use in asset management software in accordance with exemplary embodiments.

FIG. 8 is a flow diagram illustrating a process of the system of FIG. 1 for the testing of server performance of the asset management server based on scripting of recorded user actions in accordance with exemplary embodiments.

FIG. 9 is a flow chart illustrating an exemplary method for testing asset management software applications in accordance with exemplary embodiments.

Further areas of applicability of the present disclosure will become apparent from the detailed description provided hereinafter. It should be understood that the detailed description of exemplary embodiments are intended for illustration purposes only and are, therefore, not intended to necessarily limit the scope of the disclosure.

### DETAILED DESCRIPTION

### System for Displaying Context-Based Completion Values

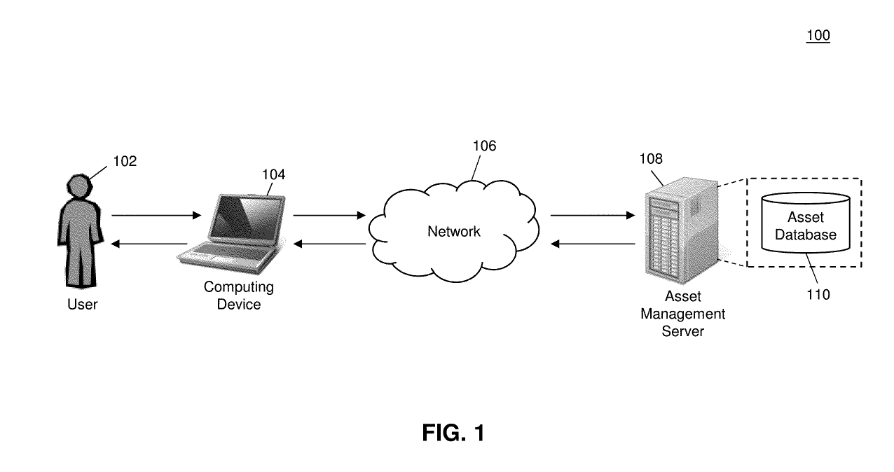

FIG. 1 illustrates a system 100 for the display of context-based completion values received from an asset database of an asset management server in an integrated development environment.

The system 100 may include a user 102. The user 102 may use a computing device 104 to access an integrated development environment. The computing device 104, discussed in more detail below, may be any type of computing device suitable for performing the functions disclosed herein such a desktop computer, laptop computer, notebook computer, tablet computer, smartphone, etc. The integrated development environment (IDE) may be executed by the computing device 104 and may include one or more editors configured to enable the user 102 to enter text, such as for a script or program code. The editor may be a part of, may utilize, may communicate via, or may otherwise be associated with an application programming interface (API) configured to interface with asset management software.

The computing device 104 may be connected to a network 106. The network 106 may be any type of network suitable for performing the functions as disclosed herein as will be apparent to persons having skill in the relevant art, such as a local area network, a wide area network, the Internet, etc. The system 100 may also include an asset management server 108. The asset management server 108 may be a computing server configured to store and execute asset management software. The asset management server 108 may include an asset database 110. The asset database 110 may be configured to store data, assets, and other information associated with the asset management software of the asset management server 108. In some embodiments, the asset database 110 may include at least one of: values, fields, relationships, methods, and attributes.

The computing device 104 may communicate with the asset management server 108 via the network 106. The editor in the IDE of the computing device 104 may access data stored in the asset database 110 via an API configured to communicate with the asset management server 108. As discussed in more detail below, the computing device 104 may retrieve context-based completion values stored in the asset database 110 of the asset management server 108 following a command by the user 102. The context-based completion values may be based on text included in the editor of the IDE executed by the computing device 104. One or more attributes may be identified based on the editor text and transmitted to the asset management server 108, which may identify a plurality of completion values in the asset database 110 based on the one or more attributes, and return the values to the computing device 104.

In some embodiments, the computing device 104 may cache the received completion values in a local memory, as discussed in more detail below. The computing device 104 may also store data to be included in the plurality of completion values, such as attributes and methods. The computing device 104 may display the plurality of completion values to the user 102. The user 102 may then select a completion value, which may be inserted into the editor at a current cursor position. In some embodiments, the plurality of completion values may be displayed via an overlay at or near the current cursor position.

By receiving completion values that are stored in the asset database 110, the computing device 104 may present the user 102 with useful information that may be unavailable in a traditional IDE. In addition, by providing completion values that are context-based, the computing device 104 may present the useful information to the user 102 with additional specificity, which may result in an even more effective interface. The computing device 104 may therefore provide for easier and more intuitive integration of an IDE with the asset management server 108, which may be further enhanced as part of a software program configured to further extend the capabilities of the asset management software, such as TRM RulesManager Studio.

In some embodiments, the asset management server 108 may also include a license compliance review tool. The license compliance review tool may be configured to retrieve stored data from the asset database 110, such as data associated with a license associated with the user 102 and/or computing device 104. In some instances, the data may be retrieved using a series of SQL statements or other suitable methods for accessing data. The asset management server 108 may analyze the retrieved data to determine if the user 102 and/or computing device 104 are in violation of one or more licenses associated with use of the data, software, hardware, and/or network, such as authorized, limited, express, or concurrent type licenses that may be issued. In some instances, the license compliance review tool may further enable the asset management server 108 to automatically populate an associated field in the asset database 110 based on the analysis, and subsequent generation of field and/or analysis results into a data format suitable for review, such as a spreadsheet. In some instances, the data format suitable for review may be available to the user 102 of the computing device 104.

### System for Guided Assistance to Users of the Asset Management Server

In some embodiments, the asset management server 108 of the system 100 illustrated in FIG. 1 may also be configured to provide guided assistance to users 102 via the computing device 104. In such embodiments, a first user 102, such as an administrator or supervisor, may create a page guide, task list, or other type of interactive instruction for use with an application of the asset management server 108. The interactive instruction may be created by the first user 102 via use of a guided assistance tool, which may be executed by the asset management server 108 and/or the computing device 104 and accessed using the computing device 104 via the network 106.

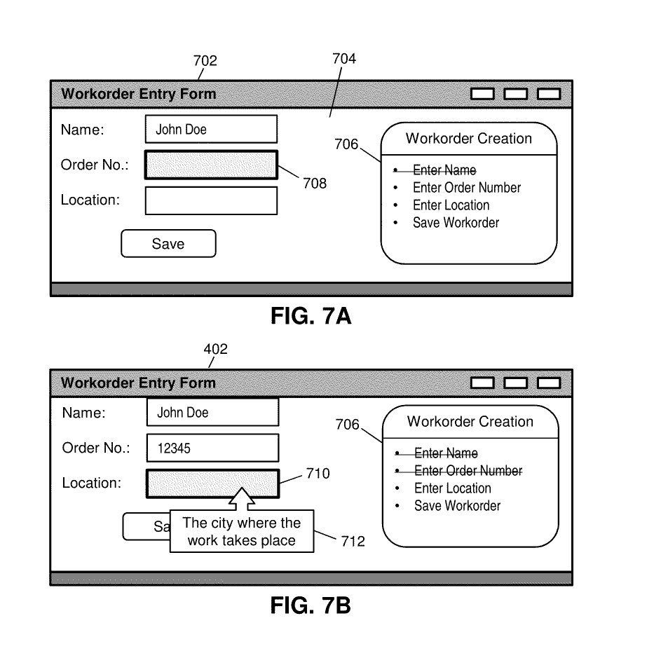

Using the guided assistance tool, the first user 102 may develop interactive instructions for use by a second user 102 in operating one or more applications of the asset management server 108, such as applications that may be native to the asset management server 108, or developed for the asset management server 108, such as a scripted application developed using context-based completion values as discussed herein. Interactive instructions may be developed by the first user 102 by inputting a list of instructions to be carried out by the second user 102 to complete a specific task. For example, the first user 102 may develop interactive instructions for the filling out of a workorder in a workorder application of the asset management server 108, such as illustrated in FIGS. 7A and 7B and discussed in more detail below.

The guided assistance tool may include an editor that is displayed to the first user 102 via the computing device 104. Using the editor, the first user 102 may select fields, values, selections, menus, etc. that are to be accessed, edited, toggled, selected, or otherwise interacted with by the second user 102. The guided assistance tool may register the action, which may be set with a specific criteria or value by the first user 102. For example, the instruction may indicate to fill out a data field in the application, but may further require a specific value or value criteria (e.g., number of characters, format, etc.) for the entered value. The first user 102 may continue making selections to comprise a list of tasks to be carried out by the second user 102 in order to fulfill an objective, such as the entry of a workorder into the system.

Once the interactive instruction has been completed by the first user 102, it may be used by the second user 102, such as to serve as a tutorial, a helpful guide, a learning tool, etc. The second user 102 may load the associated application on the asset management server 108 and may start the interactive instruction. In some embodiments, the interactive instruction may be set to start automatically, and may be further set to start automatically upon fulfillment of specific criteria (e.g., first open by a user, etc.). The second user 102 may then follow each instruction upon order of entry to complete the objective. In some instances, the interactive instruction may update the list of instructions as they are completed by the second user 102, such as by striking off, or otherwise indicated as completed, the instruction.

In some embodiments, the guided assistance tool may also enable the first user 102 to add notes, reminders, tips, hints, etc. to the interactive instructions as they are being developed. For example, the first user 102 may add a tooltip when adding an instruction for a field or menu, and may input text or other data in the tooltip to provide assistance to the second user 102. In another example, the interactive instructions may display notes for a specific instruction when that instruction is reached by the second user 102. In yet another example, the interactive instruction may include audio instructions or cues provided by the first user 102.

In some embodiments, interactive instructions may be developed for use by specific users. In some instances, interactive instructions may include specific instructions or associated data (e.g., tooltips) that are dependent on permissions or status of the second user 102. For example, a first type of user 102 may be provided different instructions for information to input into a form than a second type of user 102. In some embodiments, as instructions are completed by a second user 102, the second user 102 may mark completion of the instruction manually. In other embodiments, the asset management server 108 and/or computing device 104 may identify completion of the instruction automatically and may update the interactive instructions accordingly.

### System for Testing of Applications of the Asset Management Server

In some embodiments, the asset management server 108 may also be programmed to perform testing on applications included therein using the system 100 illustrated in FIG. 1.

In such an embodiment, a user 102 may access an application associated with the asset management server 108, such as by using the computing device 104. The user 102 may perform a plurality of user input actions to access functions of the application. The computing device 104 and/or the asset management server 108 may be configured to record the plurality of user input actions performed by the user 102. The asset management server 108 may be configured to generate a program script for a script that, when executed by the asset management serve 108, performs each of the plurality of user input actions performed by the user 102. In other words, the asset management server 108 may generate a program script to repeat the actions performed by the user 102.

Once the program script has been generated, the asset management server 108 may be configured to execute the program script to test the application. In some embodiments, the program script may be configured to perform the plurality of user input actions multiple times, such as to simulate the performance of the user input actions by a plurality of users. In other embodiments, the asset management server 108 may be configured to execute a plurality of instances of the generated program script, such as to simulate each instance of the program script as being a different user 102 performing the plurality of user input actions.

When the program script is executed by the asset management server 108, the asset management server 108, and/or an alternative device, such as the computing device 104, may be configured to monitor performance of the asset management server 108. The performance of the asset management server 108 may be measured based on any suitable criteria that will be apparent to persons having skill in the relevant art. For example, the asset management server 108 may be measured for processor usage, memory usage, processing speed, processing time, memory read speed, memory write speed, packet transfer time, etc. The computing device 104 may display the measured performance to a user 102. In some instances, the performance may be included in a report, which may be generated by the asset management server 108 for review by the user 102.

In some embodiments, the plurality of user input actions recorded and automated using the generated program script may include the input of user login credentials for logging in to the asset management server 108, such as for use of the associated application. In such embodiments, the user input action may be considered to be the input of a specific set of supplied user login credentials, a group of sets of supplied user login credentials, or any acceptable user login credentials. In instances where multiple sets of user login credentials may be indicated, the program script may be configured to, when executed by the asset management server 108, use the user login credentials for any acceptable (e.g., indicated by the user 102 and/or user permissions) user 102. In such instances, the execution of multiple instances of the program script by the asset management server 108 may include the login of a variety of different users 102. In some embodiments, each user may be associated with one or more user-specific or user-dependent queries. In such embodiments, the login of a variety of different users 102 may include the execution of various user-dependent queries, based on the queries associated with each of the different users 102 being logged in. As a result, the asset management server 108 may be configured to perform unit or load testing on an application that also includes the execution of varying user-dependent queries, which may provide for a more accurate, and therefore more effective, test of the application that is currently unavailable in computing servers, in particular asset management servers.

In some embodiments, the plurality of user input actions may include the input of one or more user assertions. A user assertion may be an assertion by a user 102 of a specific value, setting, etc. for the application to be checked during the load testing executions of instances of the subsequently generated program script. For example, there may be a user assertion for the value of a specific data field, for the state of a specific radio button, for the display of a prompt or dialog box, etc. In such instances, the measurement of the performance of the asset management server 108 may include the testing of any user assertions included in the plurality of user input actions. In some instances, the asset management server 108 may indicate a positive or negative performance (e.g., a pass or fail) based on the user assertions and the associated values generated during execution of instances of the program script. For example, if an instance of the program script generates an unacceptable value for a specific data field included in a user assertion, then the test may receive an indication of negative performance (e.g., a fail). In some instances, a test may still receive an indication of positive performance until a predetermined number of failed user assertions is met, which may be set by a user 102 initiating the test, set by the asset management server 108, by the program being test, etc.

In some embodiments, the test may be performed for a specific unit or function of an application of the asset management server 108. In such an instance, the program script may include testing of the specific unit or function, as performed by the user 102 and recorded for inclusion in the generated script. The asset management server 108 may execute a plurality of instances of the generated program script, to test the unit or function. In some instances, a user assertion may be included to ensure that each test results in a desired result, to ensure that the specific unit or function operates as desired.

### Computing Device

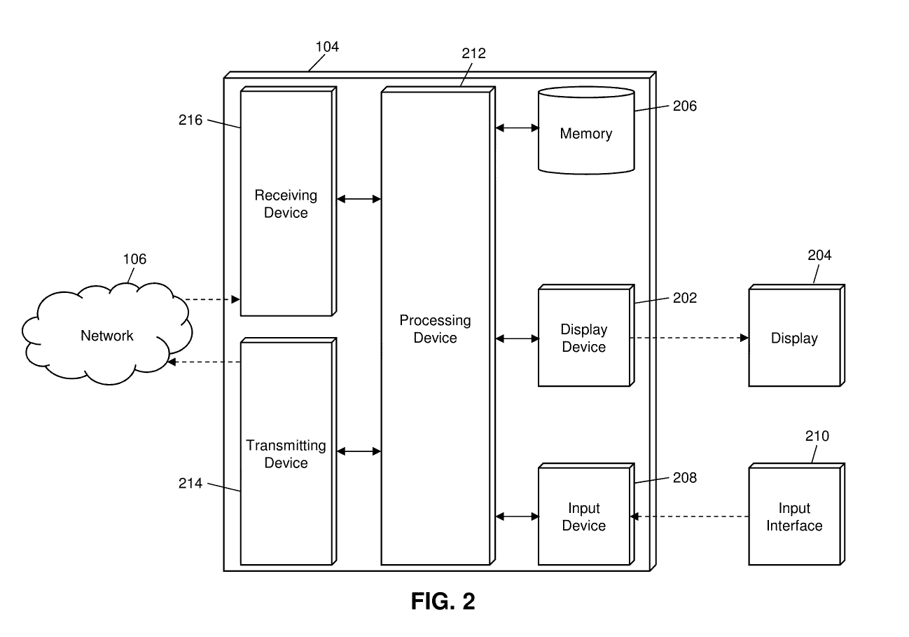

FIG. 2 illustrates an embodiment of the computing device 104 of the system 100. It will be apparent to persons having skill in the relevant art that the embodiment of the computing device 104 illustrated in FIG. 2 is provided as illustration only and may not be exhaustive to all possible configurations of a computing device 104 suitable for performing the functions as discussed herein.

The computing device 104 may include a display device 202. The display device 202 may be configured to communicate and/or interface with a display 204 to display data to the user 102. The display 204 may be any type of display suitable for performing the functions disclosed herein, such as a liquid crystal display, light-emitting diode display, touch screen display, capacitive touch display, etc. The display device 202 may be configured to transmit data to the display that is stored in a memory 206 of the computing device 104.

The memory 206 may store data suitable for performing the functions disclosed herein, such as an IDE program configured to interface or communicate with the asset management server 108. The IDE may include one or more editors suitable for enabling the user 102 to create program scripts or otherwise input text, such as text used for input into or consideration by the asset management software executed by the asset management server 108. The display device 202 may be configured to display the data to the user 102, such as a selected editor and text included therein. The display device 202 may also display a cursor position, which may indicate a point of input for text or commands input by the user 102.

The computing device 104 may receive input from the user 102 via an input device 208. The user 102 may communicate with the input device 102 via an input interface 210 that is connected to or otherwise in communication with the input device 208. The input interface 210 may be any type of input suitable for performing the functions disclosed herein, such as a keyboard, mouse, touch screen, click wheel, scroll wheel, trackball, touch bad, input pad, microphone, camera, etc. In some embodiments, the input interface 210 and the display 204 may be combined, such as in a capacitive touch display. In some instances, the display 204 and/or the input interface 210 may be included in the computing device 104. In other instances, the display 204 and/or the input interface 210 may be external to the computing device 104.

The computing device 104 may further include a processing device 212. The processing device 212 may be a central processing unit (CPU) or other processor suitable for performing the functions disclosed herein as will be apparent to persons having skill in the relevant art. The processing device 212 may receive data associated with input by the user 102, such as via the input device 208. The processing device 212 may also be configured to execute program code stored in the memory 206, such as the IDE, and to transmit data to the display device 202 for display to the user 102 via the display 204. The processing device 212 may be further configured to identify one or more completion attributes based on the editor displayed to the user 102 and/or text included therein, as discussed in more detail below. Additional functions performed by the processing device 212 will be apparent to persons having skill in the relevant art and may also be discussed herein.

The computing device 104 may also include a transmitting device 214. The transmitting device 214 may be configured to transmit data over the network 106 via one or more suitable network protocols. The transmitting device 214 may transmit the one or more completion attributes to the asset management server 108 over the network 106. The computing device 104 may also include a receiving device 216. The receiving device 216 may be configured to receive data over the network 106 via one or more suitable network protocols. The receiving device 216 may receive a plurality of completion values from the asset management server 108 over the network 106. The plurality of completion values may be based on the one or more completion attributes.

The processing device 212 may be configured to communicate the received plurality of completion values to the display device 202, which may transmit the completion values to the display 204 for display to the user 102. In some embodiments, the completion values may also be stored in a cache of the memory 206. In such an embodiment, the completion values may be retrieved from the memory 206 upon identification of the corresponding one or more completion attributes in later instances, without the need to transmit a new request to the asset management server 108. In a further embodiment, the memory 206 may clear the cache after a predetermined period of time.

In some embodiments, the memory 206 may be configured to store method and/or attribute data. In such an embodiment, the processing device 212 may be configured to retrieve completion values based on the stored method and/or attribute data and the identified one or more attributes. The processing device 212 may be configured to include the retrieved completion values in the plurality of completion values received from the asset management server 108 for display to the user 102.

In some embodiments, the computing device 104 may also be configured to provide the user 102 with an interface to using the guided assistance tool, such as for the creation of interactive instructions or the use of interactive instructions in association with an application of the asset management server 108. In such embodiments, the receiving device 216 may be configured to receive data from the asset management server 108, such as data for use and operation of an application of the asset management server 108. The receiving device 216 may also receive data associated with the guided assistance tool, such as functions and interfaces for use thereof for display to the user 102 on the display 204 via the display device 202 of the computing device 104. The user 102 may make selections of interactive instructions using the guided assistance tool via an input interface 210 connected to the computing device 104 using the input device 208.

When selections are made via the input interface 210, selection information may be transmitted to the asset management server 108 via the network 106 by the transmitting device 214. The asset management server 108 may then receive the interactive instructions (e.g., via its own receiving device 216) and develop (e.g., via its own processing device 212) a guide consisting of the interactive instructions. When a second user 102 accesses the associated application of the asset management server 108, the second user 102 may be presented with (e.g., upon fulfillment of preset criteria, such as set by the user 102 when creating the interactive instructions using the guided assistance tool) the interactive instructions, transmitted to the computing device 104 by the asset management server 108 (e.g., by its own transmitting device 214). The interactive instructions may then be displayed to the second user 102 on the display 204 via the display device 202, to assist the second user 102 in completing an associated objective. In some instances, the user 102 may submit additional criteria for use in the interactive instructions, such as settings for display of the interactive instructions to users (e.g., first time launching the application), different instructions for different levels of users or specific users, etc.

In embodiments where the computing device 104 may be configured to work in conjunction with the asset management server 108 for testing of applications of the asset management server 108, the components of the computing device 104 may be configured to perform additional functions associated thereof. For instance, the processing device 212 of the computing device 104, or a processing device of the asset management server 108, may be configured to record user input actions of a user 102 using the input interface 210 via the computing device's input device 208. The user input actions may be captured by the processing device 212 and transmitted by the transmitting device 214 to the asset management server 108 or transmitted directly to the asset management server 108 by the transmitting device 214 and captured by the asset management server's processing device.

The processing device of the asset management server 108 may then generate a program script configured to automate performance of the captured user input actions. The processing device of the asset management server 108 may be further configured to execute a plurality of instances of the program script and measure performance of the asset management server 108 during execution of the instances of the program script, such as based on processor usage, memory usage, processing speed, etc., and may be further based on such values depending on the number of instances of the program script being executed at any given time. In some instances, instances of the program script may include the logging in of various users 102, which may include the execution of varying user-dependent queries by the processing device of the asset management server 108, which may vary the processing done in each executed instance of the program script and thus provide a more accurate measurement of the asset management server's performance. In additional instances, measuring of performance may include the evaluation of user assurances included in the user input actions, such as the checking of generated values or the results of user input actions, to determine a positive or negative performance of the asset management server 108 based on the criteria set forth by the user 102 in the user assurances. Additional user-submitted information may also be included in the program script for use in the executed instances of the program script, such as user-supplied variables, login credentials, etc.

The receiving device 216 of the computing device 104 may be further configured to receive performance measurements from the asset management server 108 in connection with the performance measured during executions of instances of the program script. The performance measurements may then be displayed to a user 102 on the display 204 via the display device 202 of the computing device 104. The user 102 may review the performance measurements, which may be used for quality assurance, testing of units or applications, etc.

### Process for Identifying and Displaying Context-Based Completion Values

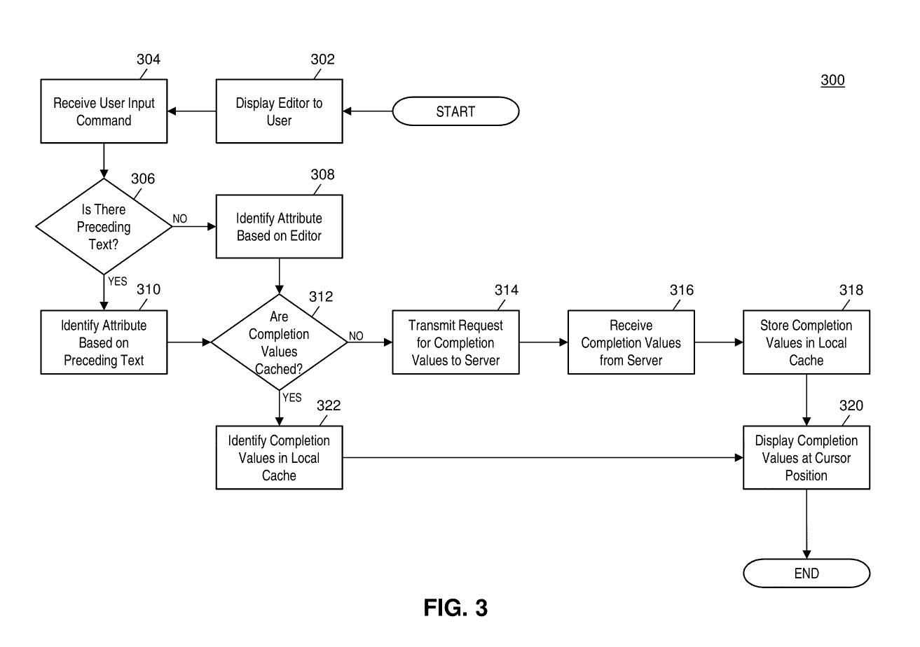

FIG. 3 illustrates a process 300 for the identification and display of completion values from an asset management server in an editor of an IDE based on the editor and/or text included therein.

In step 302, the display device 202 of the computing device 104 may display an editor to the user 102 via the display 204. The editor may be one of a plurality of editors included in an IDE configured to communicate and/or interface (e.g., via an API) with the asset management server 108 over the network 106. The displayed editor may include text and any other data suitable for performing the functions disclosed herein as will be apparent to persons having skill in the relevant art. The display device 202 may also display a cursor position in the editor, which may indicate a current position of input by the user 102.

In step 304, the input device 208 of the computing device 104 may receive an input command from the user 102 via the input interface 210. The input command may be a specific command or one of a plurality of specific commands configured to trigger the continuation of the process 300. For instance, in one example, the input command may be the inserting of a “.” character in the editor by the user 102.

In step 306, the processing device 212 of the computing device 104 may identify the text included in the editor to detect if there is any text preceding the cursor position at the time the input command is received from the user 102. In some instances, the detection may be based on the received input command. For instance, the processing device 212 may presume that there is text preceding the cursor position if the input command is a “.” character, but may presume that there is no text preceding the cursor position if the input command is a specific combination of keys on a keyboard. In other instances, the processing device 212 may identify the cursor position and the position of text inside the editor to determine if there is text preceding the cursor position.

If the processing device 212 determines that there is no text preceding the cursor position, then, in step 308, the processing device 212 may identify at least one completion attribute based on the editor currently being executed by the processing device 212 and displayed to the user 102. In one embodiment, the completion attribute may be the name or a descriptive element of the editor. If the processing device 212 determines that there is text preceding the cursor position, then, in step 310, the processing device 212 may identify at least one completion attribute based on the text preceding the cursor position. In one embodiment, the completion attribute may be a text word or value preceding the cursor position. In some embodiments, the identified at least one completion attribute may be based on partial execution and/or analysis of the text included in the editor. For instance, if the text included in the editor includes a program script, the script may be at least partially executed to identify one or more completion attributes.

One the completion attribute or attributes has been identified, then, in step 312, the processing device 212 may determine if associated completion values are cached in the memory 206. If completion values corresponding to the identified at least one completion attribute are not cached, then, in step 314, the transmitting device 214 of the computing server 104 may transmit a request for completion values to the asset management server 108 via the network 106. The asset management server 108 may then identify completion values stored in the asset database based on the at least one completion attribute. The completion values may include fields, values, relationships, methods, attributes, or other suitable data as will be apparent to persons having skill in the relevant art.

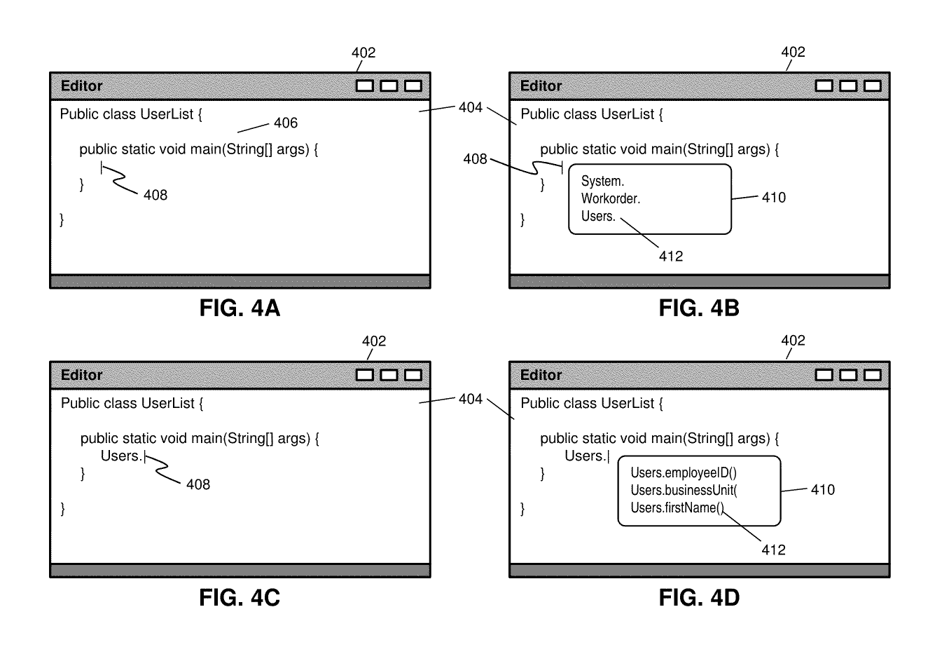

In step 316, the receiving device 216 of the computing server 104 may receive the plurality of completion values from the asset management server 108 over the network 106. In step 318, the processing device 212 may store the received completion values in the local cache of the memory 206. In step 320, the display device 202 may transmit the plurality of completion values to the display 204 for display to the user 102. In some embodiments, the completion values may be displayed at or near the cursor position, such as via an overlay or menu. An example interface for the display of completion values is illustrated in FIGS. 4A-4D and discussed below.

In instances where the completion values associated with the at least one completion attribute are cached in the memory 206, as determined in step 312, then, in step 322, the processing device 212 may identify the completion values as the desired plurality of completion values. The process 300 may then proceed to step 320, where the display device 202 may transmit the plurality of completion values to the display 204 for display to the user 102.

### Graphical User Interface for Context-Based Completion

FIGS. 4A-4D illustrate an exemplary graphical user interface of the IDE executed by the processing device 212 of the computing device 104 that is configured to display context-based completion values to the user 102. It will be apparent to persons having skill in the relevant art that the interface illustrated in FIGS. 4A-4D and discussed herein is an illustration only and that there may be alternative configurations of the interface suitable for performing the functions as disclosed herein.

FIG. 4A includes an editor window 402. The editor window 402 may be displayed by the display device 202 via the display 204 to the user for editing program scripts or otherwise inputting text that may be in communication with the asset management server 108, such as via an API. The editor window 402 may include a text area 404. The text area 404 may be an area for the display of text to the user 102. The text area 404 may also display text that is input by the user 102 as received by the input device 208 (e.g., via the input interface 210).

As illustrated in FIG. 4A, the text area 404 may include program code 406 input by the user 102. Methods and systems for receiving user input in a computing device 104 and display thereof in an area of a program stored in memory 206 and executed by a processing device 212 will be apparent to persons having skill in the relevant art. The text area 404 may also include a cursor position 408 among the program code 406 or other text. The cursor position 408 may indicate a location at which text input by the user 102 will be added to the text area 404.

As discussed above, the user 102 may input an input command into the input device 208 via the input interface 210. The input command may be transmitted to the processing device 212, which may identify the input command as triggering the process 300 discussed above. The processing device 212 may then, as discussed above, detect if there is text preceding the cursor position 408. As illustrated in FIG. 4A, the processing device 212 may not detect any text preceding the cursor position 408 and thus may identify at least one completion attribute based on the editor corresponding to the editor window 402. The processing device 212 may then identify (e.g., in a cache of the memory 206) or receive (e.g., from the asset management server 108) a plurality of completion values corresponding to the at least one completion attribute.

The display device 202 may then transmit the plurality of completion values to the display 204 for display to the user 102. As illustrated in FIG. 4B, the text area 404 may include an overlay 410 configured to display the plurality of completion values 412. In some embodiments, the overlay 410 may be located at or near the cursor position 408 and may be placed ahead (e.g., in front of) text included in the text area 404. The user 102 may then make a selection of a value in the overlay 410 via the input device 208. The processing device 212 may then insert the selected value in the text area 404 at the cursor position 408.

FIG. 4C illustrates an embodiment where there is text preceding the cursor position 408. As illustrated in FIG. 4C, the cursor position 408 may be preceded by “Users.” In such an example, the typing of the “.” character by the user 102 may be the input command that triggers the identification of the plurality of completion values. As illustrated in FIG. 4D, in such an instance, the plurality of completion values 412 may be based on the text preceding the cursor position 408. In the illustrated example, each of the completion values in the plurality of completion values are associated with the preceding text.

In an exemplary embodiment, the plurality of completion values are based on data in and/or included in the asset database 110 of the asset management server 108. In such an embodiment, the plurality of completion values 412 may change as data stored in the asset database 110 changes. For example, the plurality of completion values 412 may include database fields that may be changed during the course of business or may refer to business assets that may be added or deleted from the asset database 110. In such an instance, the user 102 may be presented with the most recent and most accurate data stored in the asset database 110, which may provide for a more effective development environment.

### Exemplary Method for Displaying Context-Based Completion Values

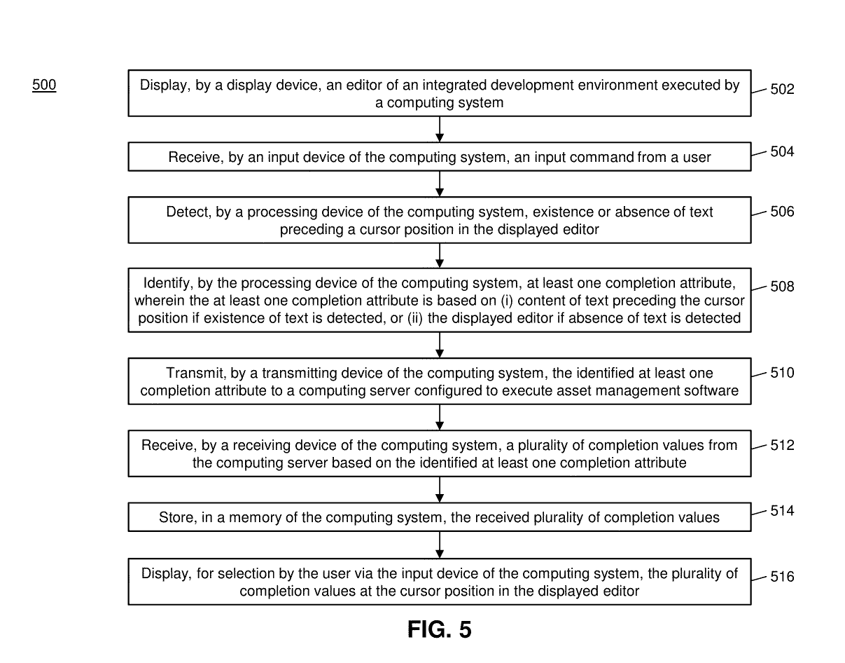

FIG. 5 illustrates a method 500 for the display of context-based completion values in an integrated development environment based on data stored in an asset database of an asset management server.

In step 502, an editor of an integrated development environment (IDE) executed by a computing system (e.g., the computing device 104) may be displayed by a display device (e.g., the display device 202). In step 504, an input command from a user (e.g., the user 102) may be received by an input device (e.g., the input device 208) of the computing system 104. In step 506, existence or absence of text preceding a cursor position in the displayed editor may be detected by a processing device (e.g., the processing device 212) of the computing system 104. In one embodiment, the detected existence or absence of text preceding the cursor position may be based on the received input command.

In step 508, at least one completion attribute may be identified by the processing device 212 of the computing system 104, wherein the at least one completion attribute is based on (i) content of text preceding the cursor position if existence of the text is detected, or (ii) the displayed editor if absence of text is detected. In one embodiment, the displayed editor may include a script, and the content of text preceding the cursor position may be based on partial execution of the script included in the displayed editor.

In step 510, the identified at least one completion attribute may be transmitted by a transmitting device (e.g., the transmitting device 214) of the computing system 104 to a computing server (e.g., the asset management server 108) configured to execute asset management software.

In step 512, a plurality of completion values may be received by a receiving device (e.g., the receiving device 216) of the computing system 104 from the computing server 108 based on the identified at least one completion attribute. In one embodiment, the plurality of completion values may include at least one of: fields and relationships of a database (e.g., the asset database 110) stored in the computing server 108 and associated with the asset management software executed by the computing server 108. In some embodiments, the plurality of completion values may include at least one of: fields, relationships, attributes, and methods.

In step 514, the received plurality of completion values may be stored in a memory (e.g., the memory 206) of the computing system 104. In one embodiment, the received plurality of completion values stored in the memory 206 of the computing system 104 may be deleted from the memory 206 after a predetermined period of time. In step 516, the plurality of completion values may be displayed for selection by the user 102 via the input device 208 of the computing system 104 at the cursor position in the displayed editor. In some embodiments, the plurality of completion values may be displayed in the displayed editor via an application programming interface (API) of the IDE.

In one embodiment, the method 500 may further include: receiving, by the input device 208 of the computing system 104, a user selection of a specific completion value of the plurality of completion values and displaying, by the display device 202, the specific completion value as inserted text at the cursor position. In some embodiments, attributes and methods associated with at least one of: the displayed editor and text included in the displayed editor may be stored in the memory 206 of the computing system 104. In a further embodiment, the method 500 may further include updating, by the processing device 212 of the computing system 104, the plurality of completion values to include the stored attributes and methods prior to displaying in the displayed editor.

### Process for Guided Assistance of User Action

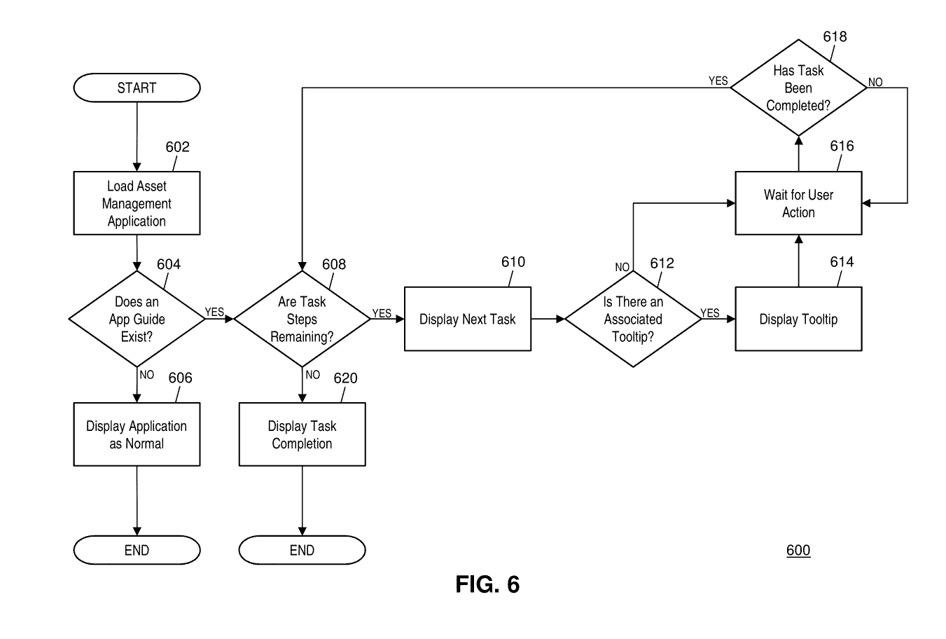

FIG. 6 illustrates a process 600 for the guided assistance of user action in applications of the asset management server 108, such as based on interactive instructions submitted by a first user 102 for use by a second user 102, such as to use as a tutorial or assistance to complete a specific objective.

In step 602, the user 102 may load an application of the asset management server 108 using the computing device 104. Loading of the application may include the input of an instruction to load the application by the user 102 of the computing device 104 received via the input device 208 and transmitted to the asset management server 108 via the transmitting device 214. The asset management server 108 may receive the instruction on its own receiving device 216, may retrieve the associated information using its own processing device 212, and may use its own transmitting device 214 to transmit the information back to the computing device 104, to be received by the receiving device 216 and displayed on the display 204 via the display device 202.

In step 204, the processing device 212 of the computing device 104 may determine if the application includes an application guide, which may consist of a plurality of interactive instructions to assist the user 102 in completing an objective, such as the filling out of a form, entering of data, identification of specific data, etc. The determination may be based on data associated with the application, such as stored in the asset management server 108 (e.g., and transmitted with the application data) or in the computing device 104. In some instances, if an application guide is identified for the application, the processing device 212 may also determine if the guide is applicable to the user 102 and/or situation, such as based on use criteria associated with the application guide. If no application guide is identified, or if an identified application guide is not applicable, then, in step 606, the application may be displayed to the user 102 as normal on the display 204 via the display device 202.

If an applicable application guide is identified, then, in step 608, the processing device 212 of the computing device 104 may determine if additional task steps (e.g., interactive instructions) are still remaining to be completed by the user 102. If there are additional tasks that have not yet been completed, then, in step 610, the processing device 212 may continue to the next task in the application guide and display data relevant to the task to the user 102 on the display 204 via the display device 202. The relevant data may include a name of the task, the highlighting or other type of indication of a specific data field, menu, selection, etc., or other data that will be apparent to persons having skill in the relevant art that may be useful to the user 102 for the completion of the task, such as audio, video, images, etc.

In step 612, the processing device 212 of the computing device 104 may determine if there is a tooltip associated with the current task. If there is a tooltip, then, in step 614, the tooltip may be displayed to the user 102 on the display 204 via the display device 202. In some instances, the tooltip may be displayed with the task itself (e.g., in a list of tasks comprising the application guide), or may be displayed on a relevant portion of the display 204, such as next to a data field or other target of user interaction that may be a goal of the current task. In step 616, the processing device 212 may wait for the input of user action. When user action has been input, received by the input device 208 of the computing device 104 via the input interface 210, then, in step 618, the processing device 212 of the computing device 104 may determine if the current task has been completed based on the user action.

Task completion may be identified based on criteria associated with the specific task included in the application guide. For example, a task may require the input of any data into a data field, completion for which may be identified by the identification of data in the data field. In another example, a task may require the navigation to a specific display page of the application, completion for which may be identified by identifying the page that is displayed upon interaction with any navigation item by the user 102. If the processing device 212 determines that the task has not yet been completed, then the process 600 may return to step 616 where the processing device 212 waits for additional user action. If the processing device 212 determines that the task has been completed, the process may return to step 608.

Once, in step 608, the processing device 212 of the computing device 104 determines that the all tasks in the application guide have been completed, then, in step 620, the display 204 may display to the user 102 that the application guide has been completed and the associated objective completed. In some embodiments, the application guide may include data to be displayed to the user 102 and/or one or more actions to be performed upon completion of the application guide. For example, information associated with the user 102 in the asset management server 108 may be updated to indicate the user's completion of the application guide, a different user 102 (e.g., a supervisor) may be notified of the user's completion of the application guide, the user 102 may be taken to a different application and corresponding application guide, etc.

### Graphical User Interface for Guided Assistance

FIGS. 7A and 7B illustrate an exemplary graphical user interface of the computing device 104 for display to the user 102 on the display 204 via the display device 202 for the display of guided assistance in completion of an objective of an application of the asset management server 108. It will be apparent to persons having skill in the relevant art that the interface illustrated in FIGS. 7A and 7B and discussed herein is an illustration only and that there may be alternative configurations of the interface suitable for performing the functions as disclosed herein.

FIG. 7A illustrates a window 702 displayed on the display 204 of the computing device 104, such as may be displayed in association with an application of the asset management server 108. In the example illustrated in FIG. 7A, the application may be for the entry of workorders into the asset management server 108. The window 702 may include a form 704, which may include a plurality of display fields, selectors, menus, navigation items, etc. In the example illustrated in FIG. 7A, the form 704 is a workorder entry form that includes three input fields and a save button.

The window 702 may also display a task window 706. The task window 706 may include a plurality of tasks and interactive instructions for completion by the user 102 in order to complete an objective. In some embodiments, the objective may also be displayed in the task window 706. For example, in the example illustrated in FIG. 7A, the task window includes four tasks for completion by the user 102 in order to fulfill the objective of creating a workorder. As indicated in the illustrated example, the user 102 is on the second task, which is the entering of an order number. The form 704 includes a corresponding order number field 706. As illustrated in FIG. 7A, the order number field 706 is highlighted, as to assist the user 102 in identification of the order number field 706 for completion of the next task in the guide.

Once the user has entered an order number into the order number field 706 and completed the next task in the guide, the task window may indicate completion of that task and the form 704 may be adjusted to account for the change in task, as illustrated in FIG. 7B. In the illustrated example, the order number has been filled in, and so the corresponding task has been marked as completed in the task window 706. The next task for completion by the user 102 is the entering of a location in the form 705, into the location field 710. As illustrated in FIG. 7B, the location field 710 may be highlighted in order to assist the user 102 in identification of the proper field as indicated by the current task. As also illustrated in FIG. 7B, the current task may also be associated with a tooltip 712. The tooltip 712 may be displayed in proximity of the location field 710 in order to further assist the user 102, such as by providing a description of the task to be completed or other information to assist the user 102 in completion of the task. In the illustrated example, the tooltip 712 conveys to the user 102 what type of data is to be entered in the location field 710, such as, in this instance, a city name. It will be apparent to persons having skill in the relevant art that the interface of the window 702 and task window 706 are provided as illustration only and that additional and/or alternative interfaces may be used to carry out the methods and systems discussed herein as will be apparent to persons having skill in the relevant art.

### Process for Testing of Asset Management Server Applications

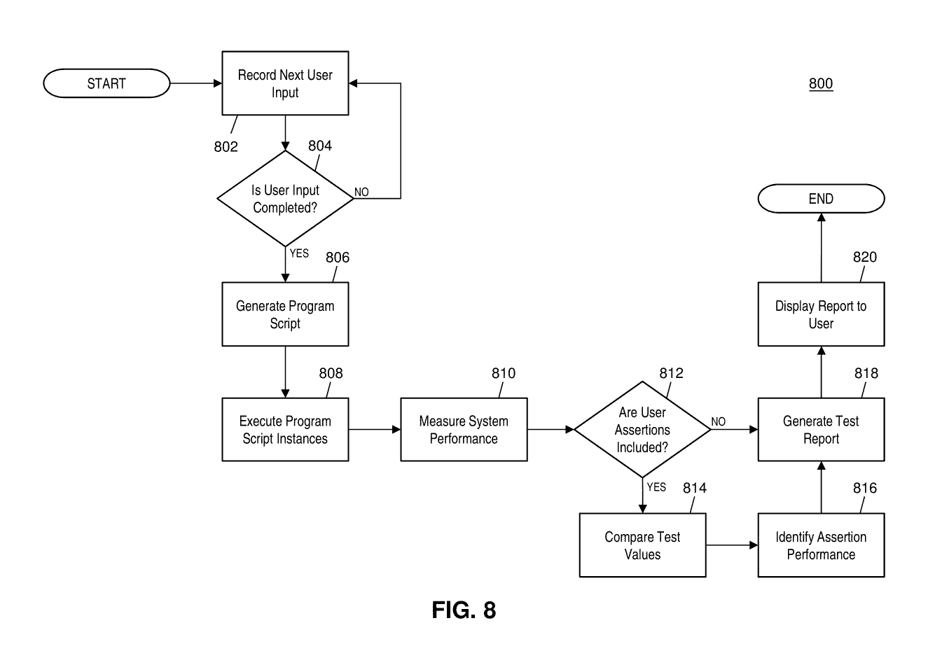

FIG. 8 illustrates a process 800 for the testing of applications on the asset management server 108.

In step 802, a user input action performed by a user 102 of the computing device 104 may be recorded. User input actions may be captured via input received by the input device 208 of the computing device 104 via the input interface 210. In some embodiments, the processing device 212 of the computing device 104 may record the user input action. In other embodiments, a processing device 212 of the asset management server 108 may record the user input action. In some instances, the computing device 104 and/or the asset management server 108 may include a separate recording device. The recorded user input action may be any suitable type of user action, such as the selection of a field, menu item, value, etc., the input of text, interaction with a navigation item, input of a user assertion, input of login credentials, input of user variables, etc.

In step 804, the processing device 212 of the computing device 104 and/or the asset management server 108 may determine if user input is completed. The determination may be based on any suitable criteria, such as the lack of a user input for a predetermined period of time, the selection of a specific item to indicate that recorded user input is completed, etc. If user input is not completed, then the process 800 may return to step 802 and continue recording user input actions. Once the user input actions have been completed, then, in step 806, a processing device 212 of the asset management server 108 may be configured to generate a program script.

The program script may be configured to, when executed by the processing device 212 of the asset management server 108, automate performance of the recorded user input actions. Performance of the recorded user input actions may include performing each of the actions performed by the user 102, and using login credentials or user variables supplied by the user 102 during the capture process, and pursuant to any other settings indicated by the user 102. For example, if the user 102 indicates that multiple sets of user login credentials are to be used, the program script may be generated by the processing device 212 of the asset management server 108 to ensure that different user login credentials are used from the multiple sets during different instances of execution of the program script.

Once the program script has been generated and user criteria or settings fulfilled, then, in step 808, the processing device 212 of the asset management server 108 may execute instances of the program script. In some embodiments, the asset management server 108 may repeat single instances of the program script, such as for testing of an individual unit of an application of the asset management server 108. In other embodiments, the asset management server 108 may execute multiple instances of the program script at any given time, such as to test performance of the asset management server 108 dependent on the load. For example, the asset management server 108 may execute five instances of the program script at one time, ten instances at another time, twenty instances at another time, etc. In some cases, the amount of instances used and the timing of execution of instances of the program script may be set by the user 102 upon initiation of step 808. For example, the user 102 may indicate that execution of the program script instances should be staggered (e.g., to simulate staggered actions by various users 102) or that all instances should be executed at the same time (e.g., to simulate a maximum potential load on the server 108).

In instances where the user input action includes the supplying of user-supplied variables or other information, instances of the program script that are executed may use the user-supplied variables and other information, such as to ensure proper simulation and measurement of server performance. In instances where the actions performed by the program script may include the logging in of users, execution of the program script may include the execution of user-dependent queries, which may vary from one user to another. In doing so, the performance of the asset management server 108 may be more accurately measured based on the logging in of different users.

In step 810, the processing device 212 of the asset management server 108 and/or the computing device 104 may measure performance of the asset management server 108 based on the executed program script instances. System performance may be measured based on processor usage, memory usage, processor speed, memory read and/or write speed, or any other suitable criteria that will be apparent to persons having skill in the relevant art. In step 812, the processing device 212 may identify if any user assertions have been included in the user input actions for consideration in the measuring of the performance of the asset management server 108. User assertions may include data values or other states of the application that are to be checked during the executed instances of the program script, such as for quality assurance. For example, a user assertion may be to check of a data field display a specific value or a value fulfilling a specific criteria, to check if an applicable dialog box successfully displays following a specific action, etc.

If the processing device 212 determines that one or more user assertions are included, then, in step 814, the processing device 212 may compare values generated during the testing instances of the program script with expected values as set forth in the user assertion. In step 816, the processing device 212 may measure performance of the asset management server 108 with respect to the user assertions. For example, if the generated value is different from the expected value, then the processing device 212 may identify a negative performance. In some instances, the performance may be an overall performance based on the performance for each of a plurality of user assertions. For example, if there are six user assertions and only two are different than the expected values during testing, then the overall performance may be positive. In some embodiments, any negative result may indicate negative performance. In some instances, the user may set a threshold for what determines negative performance, such as the number of undesired results, a measure of difference in a result, etc.

Once the performance of the asset management server 108 has been measured, including the consideration of any user assertions, then, in step 818, the processing device 212 of the asset management server 108 and/or the computing device 104 may generate a test report, which may include the performance measurements. In some embodiments, the measurements included in the report may be set by the user 102 initiating the test. In step 820, the report may be displayed to a user 102 on the display 204 of the computing device 104 via the display device 202. The user 102 may then review the report to determine the performance of the asset management server 108 with respect to the unit and/or application being tested.

### Exemplary Method for Testing Asset Management Software Applications

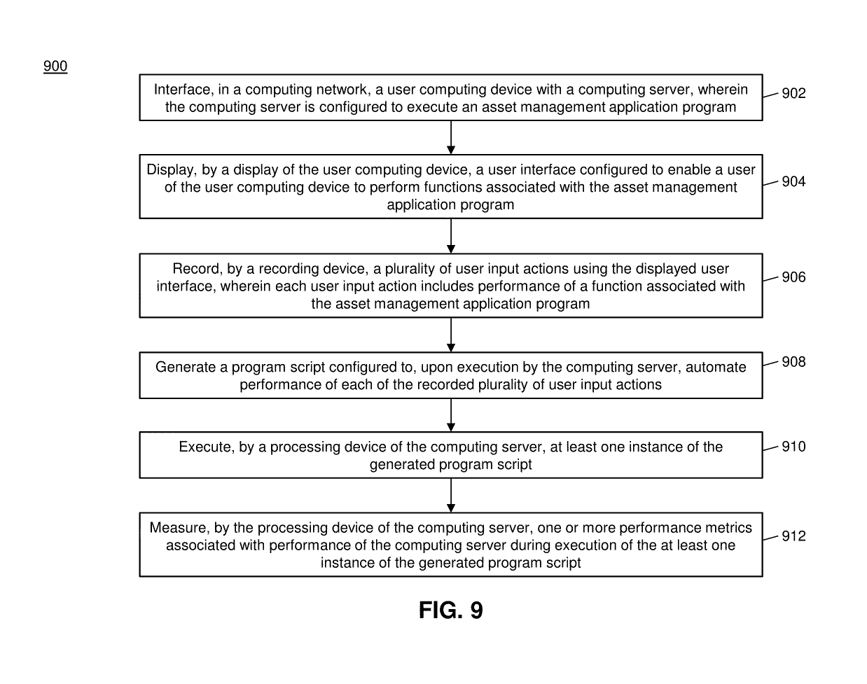

FIG. 9 illustrates a method 900 for the testing of units and/or applications in asset management software.

In step 902, a user computing device (e.g., the computing device 104) may be interfaced, in a computing network (e.g., the network 106), with a computing server (e.g., the asset management server 108), wherein the computing server 108 is configured to execute an asset management application program. In step 904, a user interface may be displayed by a display (e.g., the display 204) of the user computing device 104 configured to enable a user (e.g., the user 102) of the user computing device 104 to perform functions associated with the asset management application program.

In step 906, a plurality of user input actions using the displayed user interface may be recorded by a recording device, wherein each user input action includes performance of a function associated with the asset management application program. In one embodiment, the recording device may be included in one of: the computing server 108 and the user computing device 104. In step 908, a program script may be generated that is configured to, upon execution by the computing server 108, automate performance of each of the recorded plurality of user input actions. In one embodiment, the program script may be generated by one of: the processing device 212 of the computing server 108 and a processing device 212 of the user computing device 104. In some embodiments, the generated program script may be configured to automate performance of each of the recorded plurality of user input actions a plurality of times.

In step 910, at least one instance of the generated program script may be executed by a processing device (e.g., the processing device 212) of the computing server 108. In step 912, the processing device 212 of the computing server 108 may measure one or more performance metrics associated with performance of the computing server 108 during execution of the at least one instance of the generated program script. In one embodiment, the method 900 further includes displaying, by the display 204 of the user computing device 104, the measured one or more performance metrics.

In some embodiments, executing at least one instance of the generated program script may include executing a plurality of instances of the generated program script, where the processing device 212 of the computing server 108 is configured to stagger execution of instances of the generated program script such that a number of instances of the generated program script being executed varies over time. In a further embodiment, the one or more performance metrics may include a measure of performance based on the number of instances of the generated program script executed by the processing device 212 of the computing server 108.

In one embodiment, the plurality of user input actions may include at least one user assertion indicating a desired data value in a field of an asset database (e.g., the asset database 110) stored in the computing server 108. In a further embodiment, the one or more performance metrics may include an indication of positive or negative performance based on a correspondence between a generated data value in the field of the asset database 110 during execution of the generated program script for each of the at least one user assertion and the corresponding indicated desired data value.

In some embodiments, the plurality of user input actions may include the input of login credentials associated with one of a plurality of registered users. In a further embodiment, executing at least one instance of the generated program script may include executing a plurality of instances of the generated program script where the automated performance of each of the plurality of user input actions includes the input of login credentials for one of the plurality of registered users such that login credentials for each of the plurality of registered users are input among the plurality of instances of the generated program script executed by the processing device 212 of the computing server 108. In an even further embodiment, the plurality of registered users may be associated with one or more user-dependent queries, and wherein input of login credentials for the respective registered user includes execution, by the processing device 212 of the computing server 108, each of the associated one or more user-dependent queries.

Techniques consistent with the present disclosure provide, among other features, systems and methods for displaying context-based completion values. While various exemplary embodiments of the disclosed system and method have been described above it should be understood that they have been presented for purposes of example only, not limitations. It is not exhaustive and does not limit the disclosure to the precise form disclosed. Modifications and variations are possible in light of the above teachings or may be acquired from practicing of the disclosure, without departing from the breadth or scope.

What is claimed is:

1. A method for testing asset management software applications, comprising:
interfacing, in a computing network, a user computing device with a computing server, wherein the computing server is configured to execute an asset management application program;
displaying, by a display of the user computing device, a user interface configured to enable a user of the user computing device to perform functions associated with the asset management application program;
recording, by a recording device, a plurality of user input actions using the displayed user interface, wherein each user input action includes performance of a function associated with the asset management application program;
generating a program script configured to, upon execution by the computing server, automate performance of each of the recorded plurality of user input actions;
executing, by a processing device of the computing server, at least one instance of the generated program script; and
measuring, by the processing device of the computing server, one or more performance metrics associated with performance of the computing server during execution of the at least one instance of the generated program script.

2. The method of claim 1, further comprising:
displaying, by the display of the user computing device, the measured one or more performance metrics.

3. The method of claim 1, wherein the program script is generated by one of: the processing device of the computing server and a processing device of the user computing device.

4. The method of claim 1, wherein the recording device is included in one of: the computing server and the user computing device.

5. The method of claim 1, wherein executing at least one instance of the generated program script includes executing a plurality of instances of the generated program script, where the processing device of the computing server is configured to stagger execution of instances of the generated program script such that a number of instances of the generated program script being executed varies over time.

6. The method of claim 5, wherein the one or more performance metrics includes a measure of performance based on the number of instances of the generated program script executed by the processing device of the computing server.

7. The method of claim 1, wherein the generated program script is configured automate performance of each of the recorded plurality of user input actions a plurality of times.

8. The method of claim 1, wherein the plurality of user input actions includes at least one user assertion indicating a desired data value in a field of an asset database stored in the computing server.

9. The method of claim 8, wherein the one or more performance metrics includes an indication of positive or negative performance based on a correspondence between a generated data value in the field of the asset database during execution of the generated program script for each of the at least one user assertion and the corresponding indicated desired data value.

10. The method of claim 1, wherein the plurality of user input actions includes the input of login credentials associated with one of a plurality of registered users.

11. The method of claim 10, wherein executing at least one instance of the generated program script includes executing a plurality of instances of the generated program script where the automated performance of each of the plurality of user input actions includes the input of login credentials for one of the plurality of registered users such that login credentials for each of the plurality of registered users are input among the plurality of instances of the generated program script executed by the processing device of the computing server.

12. The method of claim 11, wherein each of the plurality of registered users is associated with one or more user-dependent queries, and wherein input of login credentials for the respective registered user includes execution, by the processing device of the computing sever, each of the associated one or more user-dependent queries.

13. A system for testing asset management software applications, comprising:
a computing network configured to interface a user computing device with a computing server, wherein the computing server is configured to execute an asset management application program;
a display of the user computing device configured to display a user interface configured to enable a user of the user computing device to perform functions associated with the asset management application program;
a recording device configured to record a plurality of user input actions using the displayed user interface, wherein each user input action includes performance of a function associated with the asset management application program;
a first processing device configured to generate a program script configured to, upon execution by the computing server, automate performance of each of the recorded plurality of user input actions; and
a processing device of the computing server configured to
execute at least one instance of the generated program script, and
measure one or more performance metrics associated with performance of the computing server during execution of the at least one instance of the generated program script.

14. The system of claim 13, wherein the display of the user computing device is further configured to display the measured one or more performance metrics.

15. The system of claim 13, wherein the first processing device and the processing device of the computing server are the same device.

16. The system of claim 13, wherein the recording device is included in one of: the computing server and the user computing device.

17. The system of claim 13, wherein executing at least one instance of the generated program script includes executing a plurality of instances of the generated program script, where the processing device of the computing server is configured to stagger execution of instances of the generated program script such that a number of instances of the generated program script being executed varies over time.

18. The system of claim 17, wherein the one or more performance metrics includes a measure of performance based on the number of instances of the generated program script executed by the processing device of the computing server.

19. The system of claim 13, wherein the generated program script is configured automate performance of each of the recorded plurality of user input actions a plurality of times.

20. The system of claim 13, wherein the plurality of user input actions includes at least one user assertion indicating a desired data value in a field of an asset database stored in the computing server.

21. The system of claim 20, wherein the one or more performance metrics includes an indication of positive or negative performance based on a correspondence between a generated data value in the field of the asset database during execution of the generated program script for each of the at least one user assertion and the corresponding indicated desired data value.

22. The system of claim 13, wherein the plurality of user input actions includes the input of login credentials associated with one of a plurality of registered users.

23. The system of claim 22, wherein executing at least one instance of the generated program script includes executing a plurality of instances of the generated program script where the automated performance of each of the plurality of user input actions includes the input of login credentials for one of the plurality of registered users such that login credentials for each of the plurality of registered users are input among the plurality of instances of the generated program script executed by the processing device of the computing server.

24. The system of claim 23, wherein each of the plurality of registered users is associated with one or more user-dependent queries, and wherein input of login credentials for the respective registered user includes execution, by the processing device of the computing sever, each of the associated one or more user-dependent queries.
